(19) United States
(12) Patent Application Publication
(10) Pub. No.: US 2013/0333916 A1
(43) Pub. Date: Dec. 19, 2013

(54) ELECTRIC WIRE

(71) Applicants: Takayuki Matsuno, Susono-shi (JP); Hiroshi Miyazawa, Susono-shi (JP)

(72) Inventors: Takayuki Matsuno, Susono-shi (JP); Hiroshi Miyazawa, Susono-shi (JP)

(73) Assignee: Yazaki Corporation, Tokyo (JP)

(21) Appl. No.: 14/001,974

(22) PCT Filed: Feb. 24, 2012
(86) PCT No.: PCT/JP2012/001270

§ 371 Date: Aug. 28, 2013

(30) Foreign Application Priority Data
Mar. 1, 2011 (JP) 2011-043773

(51) Int. Cl. H01B 1/02

(52) U.S. Cl. CPC H01B 1/023
USPC 174/110 R

(57) ABSTRACT

An electric wire includes: a core wire made by stranding a plurality of element wires each of which is made of aluminum or aluminum alloy, and has a circular sectional shape; and an insulating cover covering the core wire. The number of the element wires is equal to or more than 19 and equal to or less than 37. A diameter of the element wire is equal to or more than 0.15 mm, and equal to or less than 0.30 mm. A total cross-sectional area of the stranded element wires is equal to or more than 0.34 mm² and equal to or less than 2.61 mm². A strand pitch of the stranded element wires is equal to or more than 3 times and equal to or less than 40 times of a center diameter ‘B’ of the core wire.

### TECHNICAL FIELD

This invention relates to an electric wire having a core wire of which element wire is made of aluminum or aluminum alloy.

### BACKGROUND ART

Conventionally, for saving weight of a wiring harness routed in a vehicle, there is proposed an element wire of a core wire of an electric wire made of aluminum or aluminum alloy instead of typical cupper or cupper alloy (For example, see PLT 1 and PLT 2).

The electric wire described in the PLT 1 and the PLT 2 is a component of the above-described wiring harness and a terminal is crimped at an end of a core wire of the electric wire.

### CITATION LIST

### Patent Literature

[PLT 1]

JP, A, 2006-253093

[PLT 2]

JP, A, 2006.253076

### SUMMARY OF INVENTION

### Technical Problem

However, in the electric wire described in the Patent Documents 1 and 2, the core wire is made of aluminum or aluminum alloy which has less strength than copper or copper alloy which is conventionally used. Therefore, when the electric wire is used in a position where the electric wire is bent repeatedly such as a door in a vehicle, the element wire of the core wire of the electric wire may be broken.

Further, in the electric wire described in the Patent Documents 1 and 2, a diameter of the element wire of the core wire of the electric wire is 0.05 to 0.12 mm, which is too thin for aluminum and aluminum alloy. Therefore, productivity of the element wire made of aluminum or aluminum alloy is reduced. Further, in a case that the diameter of the element wire is too thick, when the electric wire is bent, the element wire is largely distorted, and when the electric wire is bent and stretched repeatedly, the electric wire may be broken earlier.

Further, in the electric wire described in the Patent Documents 1 and 2, a strand pitch of the element wire of the core wire of the electric wire is 30 to 50 times of an outer diameter of a strand wire, and the strand pitch is too wide, thereby an extra length of the element wire is insufficient. Therefore, when the electric wire is bent, a distortion generated in the element wire becomes large, and the flexibility of the electric wire is reduced. Further, in the electric wire described in the Patent Documents 1 and 2, the number of repetitive bending times is up to 1000, and the element wire of the core wire of the electric wire is easy to be broken. Therefore, there is a fear that the element wire may be broken when the electric wire is used in the door described above.

Accordingly, an object of the present invention is to provide an electric wire able to prevent an element wire made of aluminum or aluminum alloy from being broken even when used in a wiring harness routed in a vehicle.

### Solution to Problem

For attaining the object, according to the invention claimed in claim 1, there is provided an electric wire comprising:

a core wire made by stranding a plurality of element wires, each of said element wire being made of aluminum or aluminum alloy, and each of said element wire having a circular sectional shape; and

an insulating cover covering the core wire,

wherein the number of the element wires is equal to or more than 19 and equal to or less than 37,

wherein a diameter of the element wire is equal to or more than 0.15 mm, and equal to or less than 0.30 mm,

wherein a total cross-sectional area of the stranded element wires is equal to or more than 0.34 mm² and equal to or less than 2.61 mm², and

wherein a strand pitch of the stranded element wires is equal to or more than 3 times and equal to or less than 40 times of a center diameter of the core wire.

According to the invention claimed in claim 2, there is provided an electric wire comprising:

a core wire made by stranding a plurality of element wires, each of said element wire being made of aluminum or aluminum alloy, and each of said element wire having a circular sectional shape; and

an insulating cover covering the core wire,

wherein the number of the element wires is equal to or more than 37 and equal to or less than 84,

wherein a diameter of the element wire is equal to or more than 0.15 mm, and equal to or less than 0.315 mm,

wherein a total cross-sectional area of the stranded element wires is equal to or more than 0.65 mm² and equal to or less than 6.54 mm², and

wherein a strand pitch of the stranded element wires is equal to or more than 3 times and equal to or less than 40 times of a center diameter of the core wire.

### Advantageous Effects of Invention

According to the invention claimed in claim 1, in the electric wire of the present invention, the number of the element wires is equal to or more than 19 and equal to or less than 37, a diameter of the element wire is equal to or more than 0.15 mm, and equal to or less than 0.30 mm, and a total cross-sectional area of the stranded element wires is equal to or more than 0.34 mm² and equal to or less than 2.61 mm². Therefore, the diameter of the element wire of the electric wire is not too thin and not too thick in comparison with a diameter of the element wire of the core wire of the electric wire which is conventionally used.

Therefore, the diameter of the element wire as a component of the core wire of the electric wire is not too thin and not too thick in comparison with a diameter of the element wire of the core wire of the electric wire which is conventionally used. Further, the number of the element wires is larger than the number of the element wires of the core wire of the electric wire which is conventionally used. Therefore, bearing force of the electric wire against the tensile stress or compressive stress is increased. Further, because the element wire is not largely distorted when the electric wire is bent, flex resistance is increased.

Further, by specifying the diameter of the element wire, the element wire made of aluminum or aluminum alloy is prevented from being cut while producing the element wire caused by too thin element wire.

According to the invention claimed in claim 2, in the electric wire of the present invention, the number of the element wires is equal to or more than 37 and equal to or less than 84, a diameter of the element wire is equal to or more than 0.15 mm, and equal to or less than 0.315 mm, and a total cross-sectional area of the stranded element wires is equal to or more than 0.65 mm² and equal to or less than 6.54 mm². Therefore, the diameter of the element wire of the electric wire is not too thin and not too thick in comparison with a diameter of the element wire of the core wire of the electric wire which is conventionally used.

Therefore, the diameter of the element wire as a component of the core wire of the electric wire is not too thin and not too thick in comparison with a diameter of the element wire of the core wire of the electric wire which is conventionally used. Further, the number of the element wires is larger than the number of the element wires of the core wire of the electric wire which is conventionally used. Therefore, bearing force of the electric wire against the tensile stress or compressive stress is increased. Further, because the element wire is not largely distorted when the electric wire is bent, flex resistance is increased.

Further, by specifying the diameter of the element wire, the element wire made of aluminum or aluminum alloy is prevented from being cut while producing the element wire caused by too thin element wire.

### BRIEF DESCRIPTION OF DRAWINGS

FIG. 1 is a perspective view showing an electric wire according to a first embodiment of the present invention.

FIG. 2 is a sectional view taken on line II-II of FIG. 1.

FIG. 3 is a schematic view showing a strand pitch of element wires of a core wire.

FIG. 4 is a perspective view showing an electric wire according to a second embodiment of the present invention.

FIG. 5 is a sectional view taken on line V-V of FIG. 4.

FIG. 6 is an explanatory view showing a relationship between the electric wire and a jig when the electric wire is repeatedly bent.

FIG. 7 is a graph showing a relationship between the number of element wires, a diameter of element wire, and the number of bending when the number of bending for breaking the element wire is measured.

FIG. 8 is a graph showing a relationship between the number of element wires, a diameter of element wire, and the number of bending when the number of bending for breaking the element wire is measured.

FIG. 9 is a graph showing a relationship between a magnification of a strand pitch for a center diameter and the number of bending when the number of bending for breaking the element wire is measured.

### DESCRIPTION OF EMBODIMENTS

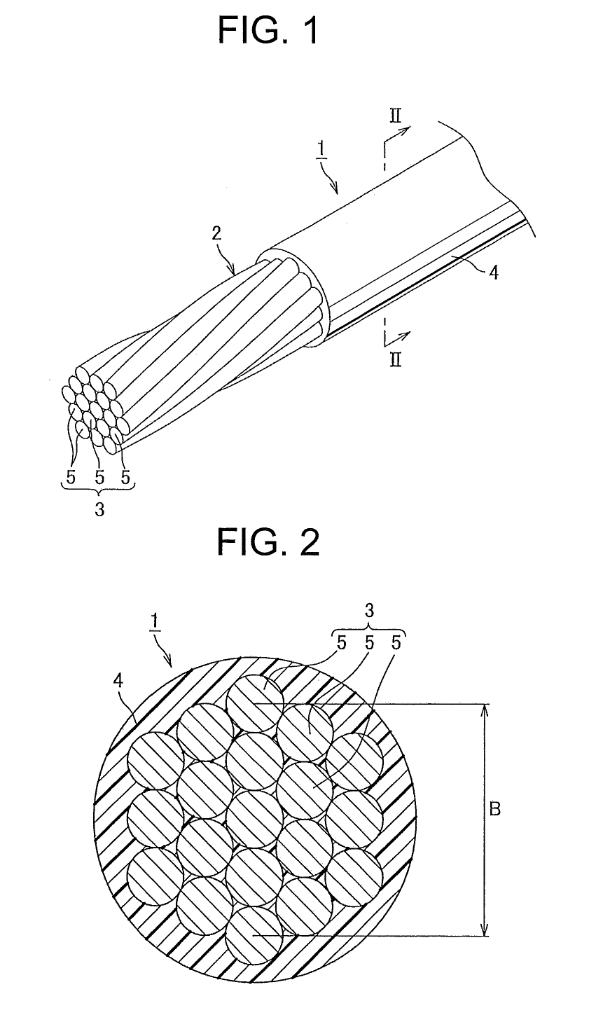

Hereinafter, an embodiment of the present invention will be explained with reference to FIGS. 1 to 5.

### Example 1

As shown in FIGS. 1 and 2, an electric wire 1 according to a first embodiment of the present invention includes: a conductive core wire 3; and an insulating cover 4. The electric wire 1 is formed in a circular sectional shape. At an end 2 of the electric wire 1, the cover 4 is removed, and the core wire 3 is exposed.

The core wire 3 includes a plurality of element wires 5. As shown in FIGS. 1 and 2, for example, the number of the element wires is 19. Each of the element wire is made of aluminum or aluminum alloy as conductive metal. The element wire 5 made of aluminum means that the element wire 5 made of only aluminum and unavoidable impurities. The element wire 5 made of aluminum alloy means that the element wire 5 made of only aluminum alloy and unavoidable impurities. Incidentally, 19 element wires are shown as an example, however, according to this embodiment, the number of the element wires 5 is equal to or more than 19 and equal to or less than 37.

The element wire 5 is made of a bar shaped metal material made of aluminum or aluminum alloy which is inserted into a hole of a not-shown die and pulled out. Namely, the element wire 5 is formed in a circular sectional shape. A diameter of the element wire 5 is equal to or more than 0.15 mm, and equal to or less than 0.30 mm. Therefore, a total cross-sectional area of the stranded element wires 5 is equal to or more than 0.34 mm² and equal to or less than 2.61 mm², and preferably, equal to or more than 0.45 mm² and equal to or less than 1.40 mm².

The core wire 3 is made by stranding a plurality of element wires 5 with a center axis of the core wire 3 and putting them together. Namely, the core wire 3 is made by stranding a plurality of element wires 5, each of said element wire 5 is formed in a circular sectional shape. Therefore, the element wires 5 as a component of the core wire 3 are wound each other in a spiral manner.

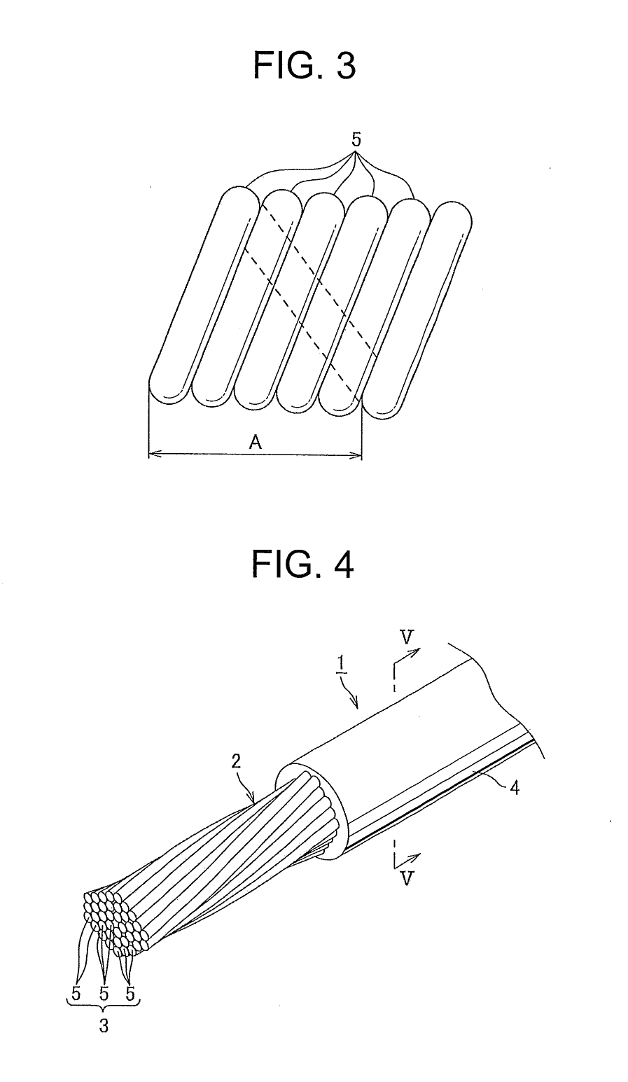

A strand pitch ‘A’ (shown in FIG. 3) of the element wires 5 of the core wire 3 is equal to or more than 3 times and equal to or less than 40 times of a center diameter ‘B’ (shown in FIG. 2) of the core wire 3. Namely, the element wires 5 of the core wire 3 is stranded in a manner that the strand pitch ‘A’ is equal to or more than 3 times and equal to or less than 40 times of a center diameter ‘B’ of the core wire 3. Therefore, when the strand of the element wire 5 is released, a length per unit length of the element wire 5 is longer than an element wire of a core wire of an electric wire conventionally used.

As schematically shown in FIG. 3, the strand pitch ‘A’ of the present invention indicates a distance between a specific position of the spirally curved element wire 5 in a circumferential direction of the core wire 3 and the specific position in the circumferential direction extending one round around the core wire 3 and returned. Namely, the strand pitch ‘A’ indicates a size where the element wire 5 is extended one round and returned back to the same position.

As shown in FIG. 2, the center diameter ‘B’ of the present invention indicates a value that a maximum outer diameter of the core wire 3 minus an outer diameter of one element wire 5, namely, an outer diameter of a circle passing the center axis of the element wire 5 positioned at the most peripheral position.

Incidentally, owing to the diameter of the element wire 5, it is physically impossible that the strand pitch ‘A’ is less than three times of the center diameter ‘B’ of the core wire 3. Namely, in the core wire 3 made by stranding a plurality of the element wires 5, the strand pitch ‘A’ is inevitably equal to or more than three times of the center diameter ‘B’ of the core wire 3.

Further, in this embodiment, preferably, the strand pitch ‘A’ of the element wires 5 of the core wire 3 is equal to or more than 10 times and equal to or less than 20 times of the center diameter ‘B’ of the core wire 3.

The cover 4 is made of insulating synthetic resin such as polyvinyl chloride resin, and covers the core wire 3. A sectional shape of the cover 4 is a ring shape.

A not-shown terminal is attached to the core wire 3 exposed at the end 2 of the above-described electric wire 1, and this terminal is attached to a not-shown connector housing, thereby assembled to a wiring harness routed in a vehicle.

The electric wire 1 according to this embodiment includes: the core wire 3 made by stranding a plurality of element wires 5 each of which is made of alumina no or aluminum alloy, and has a circular sectional shape; and the insulating cover 4 covering the core wire 3. The number of the element wires 5 is equal to or more than 19 and equal to or less than 37. A diameter of the element wire 5 is equal to or more than 0.15 mm, and equal to or less than 0.30 mm. A total cross-sectional area of the stranded element wires 5 is equal to or more than 0.34 mm² and equal to or less than 2.61 mm². A strand pitch of the stranded element wires 5 is equal to or more than 3 times and equal to or less than 40 times of a center diameter ‘B’ of the core wire 3.

Therefore, the diameter of the element wire 5 of the electric wire 1 is not too thin and not too thick in comparison with a diameter of the element wire of the core wire of the electric wire which is conventionally used. Further, the number of the element wires is larger than the number of the element wires of the core wire of the electric wire which is conventionally used. Therefore, flex resistance is increased.

Further, by specifying the diameter of the element wire, the element wire made of aluminum or aluminum alloy is prevented from being cut while producing the element wire caused by too thin element wire.

### Example 2

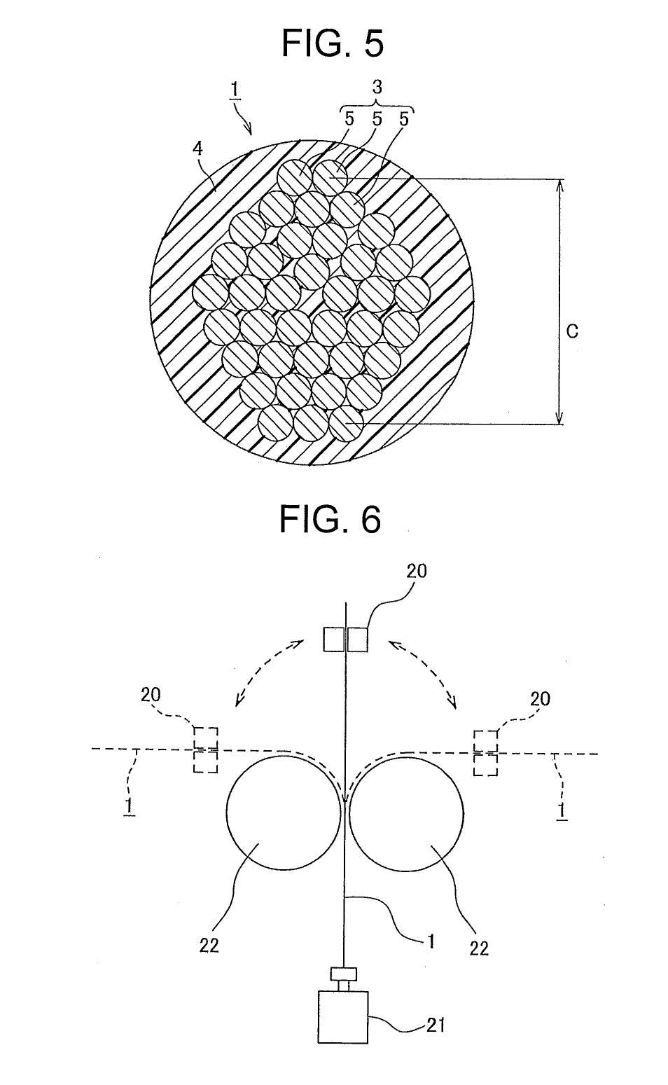

Next, the electric wire 1 according to a second embodiment of the present invention will be explained with reference to FIGS. 4 and 5. Incidentally, the same reference sign is denoted to the same component as the first embodiment, and an explanation is omitted.

In this embodiment, as shown in FIGS. 4 and 5, the number of the element wires 5 of the core wire is 38. Incidentally, 38 element wires are shown as an example, however, according to this embodiment, the number of the element wires 5 is equal to or more than 37 and equal to or less than 84.

Further, in this embodiment, a diameter of the element wire 5 of the core wire 3 is equal to or more than 0.15 mm, and equal to or less than 0.315 mm. Therefore, a total cross-sectional area of the stranded element wires 5 of the core wire 3 is equal to or more than 0.65 mm² and equal to or less than 6.54 mm², and preferably, equal to or more than 1.40 mm² and equal to or less than 2.90 mm².

The strand pitch ‘A’ of the element wires 5 of the core wire 3 is equal to or more than 3 times and equal to or less than 40 times of the center diameter ‘B’ of the core wire 3. Therefore, when the strand of the element wire 5 is released, a length per unit length of the element wire 5 is longer than an element wire of a core wire of an electric wire conventionally used.

The electric wire 1 according to this embodiment includes: the core wire 3 made by stranding a plurality of element wires 5 each of which is made of aluminum or aluminum alloy, and has a circular sectional shape; and the insulating cover 4 covering the core wire 3. The number of the element wires 5 is equal to or more than 37 and equal to or less than 84. A diameter of the element wire 5 is equal to or more than 0.15 mm, and equal to or less than 0.315 mm. A total cross-sectional area of the stranded element wires 5 is equal to or more than 0.65 mm² and equal to or less than 6.54 mm². A strand pitch of the stranded element wires 5 is equal to or more than 3 times and equal to or less than 40 times of a center diameter ‘B’ of the core wire 3.

Therefore, the diameter of the element wire 5 of the electric wire 1 is not too thin and not too thick in comparison with a diameter of the element wire of the core wire of the electric wire which is conventionally used. Further, the number of the element wires is larger than the number of the element wires of the core wire of the electric wire which is conventionally used. Therefore, flex resistance is increased.

Further, by specifying the diameter of the element wire, the element wire made of aluminum or aluminum alloy is prevented from being cut while producing the element wire caused by too thin element wire.

Measurement of the number of bending times until the element wire is broken

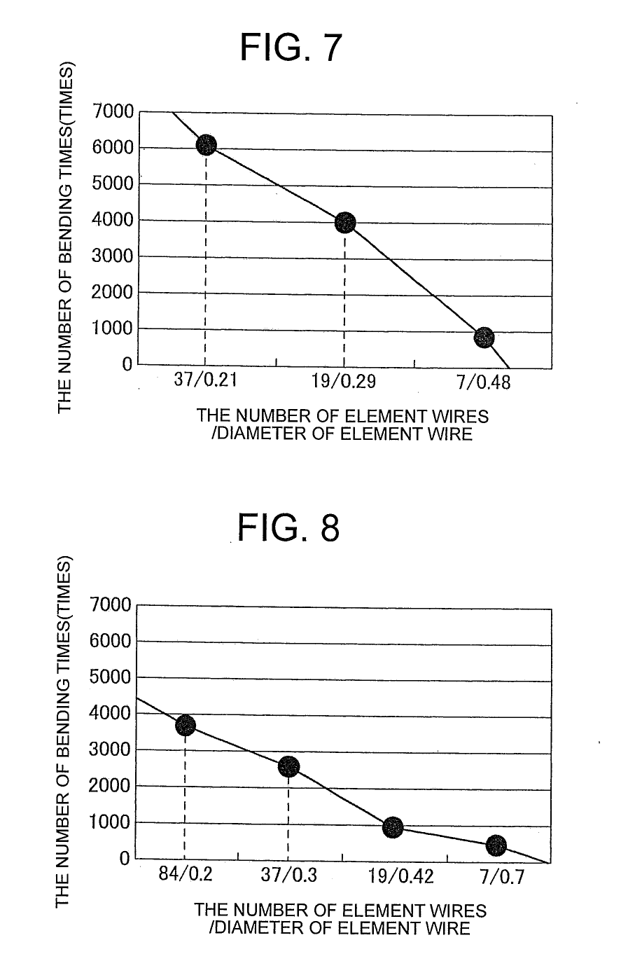

Next, the inventers of the present invention have produced the electric wire 1 according to the present invention, an electric wire of which the numbers of the element wires 5 is departing from the scope of the present invention, an electric wire of which a diameter of the element wire 5 is departing from the scope of the present invention, and an electric wire of which a strand pitch of the element wire 5 is departing from the scope of the present invention, and measured the number of bending times until at least one element wire 5 is broken by bending repeatedly these electric wires. The result is shown in FIGS. 7 to 9.

Horizontal axes of the graphs shown in FIGS. 7 and 8 indicate the number of the element wires 5, and the diameter of the element wire 5, and vertical axes indicate the bending times until at least one element wire 5 is broken. In various electric wires in the graph shown in FIG. 7, the total cross-sectional area of the stranded element wires 5 is 1.25 mm². In various electric wires in the graph shown in FIG. 8, the total cross-sectional area of the stranded element wires 5 is 2.50 mm².

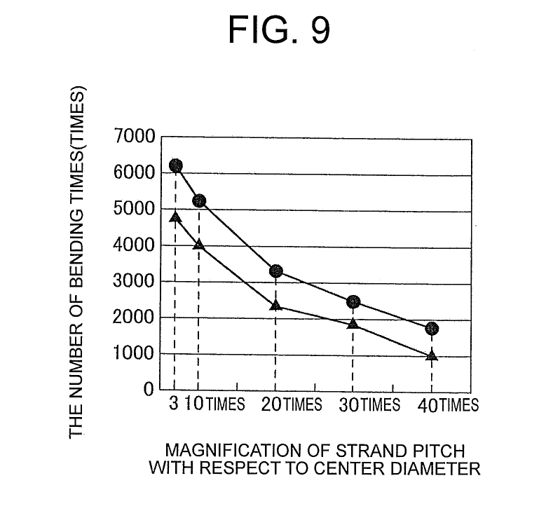

A horizontal axis of the graph shown in FIG. 9 indicates a magnification of the strand pitch ‘A’ with respect to the center diameter ‘B’ of the element wires 5 of the core wire 3, and a vertical axis indicates the bending times until at least one element wire 5 is broken. In various electric wires in the graph shown in FIG. 9, the total cross-sectional area of the stranded element wires 5 is 2.50 mm². An upper broken line in the graph shown in FIG. 9 corresponds to a case where the number of element wires 5 is 84, and the diameter of the element wire 5 is 0.2 mm. A lower broken line corresponds to a case where the number of element wires 5 is 37, and the diameter of the element wire 5 is 0.3 mm.

Further, as shown in FIG. 6, when the electric wire 1 is repeatedly bent, an end (upper end) of the electric wire 1 is fixed to a jig 20, the other end (lower end) is attached to a weight 21, and the electric wire 1 is inserted into a bending jig 22 composed of two cylinders. Then, the jig 20 is moved to one cylinder side of the bending jig 22, and the one end of the electric wire 1 is bent along an outer peripheral wall of the one cylinder. Then, the jig 20 is moved to the other cylinder side, and the one end of the electric wire 1 is bent along an outer peripheral wall of the other cylinder. In this way, the electric wire 1 is alternately and repeatedly bent in the directions opposite to each other. When the number of bending times is equal to or more than 1000, the electric wire 1 has enough performance to be used in a wiring harness in a vehicle.

According to FIG. 7, when the number of the element wire 5 is equal to or more than 19 and equal to or less than 37, and the diameter of the element wire 5 is equal to or more than 0.15 mm and equal to or less than 0.30 mm, the number of bending times can be equal to or more than 1000. Therefore, even when used in a wiring harness routed in a vehicle, the element wire 5 of the electric wire 1 of the first embodiment made of aluminum or aluminum alloy can be prevented from being broken. Namely, fatigue strength of the element wire 5 can be improved.

Further, according to FIG. 7, in the electric wire 1 having a relatively thin core wire 3 of which total cross-sectional area of the stranded element wires 5 is 1.25 mm², when the number of the element wires 5 is less than 19, the bending times until at least one element wire 5 is broken is drastically reduced due to a degradation of mechanical strength. Further, when the number of the element wires 5 is more than 37, an outer diameter of the core wire 3 is thick, and rigidity of the core wire 3 is increased, thereby flexibility of the electric wire 1 is reduced.

According to FIG. 8, when the number of the element wire 5 is equal to or more than 37 and equal to or less than 84, and the diameter of the element wire 5 is equal to or more than 0.15 mm and equal to or less than 0.315 mm, the number of bending times can be equal to or more than 1000. Therefore, even when used in a wiring harness routed in a vehicle, the element wire 5 of the electric wire 1 of the second embodiment made of aluminum or aluminum alloy can be prevented from being broken. Namely, fatigue strength of the element wire 5 can be improved.

Further, according to FIG. 8, in the electric wire 1 having a relatively thick core wire 3 of which total cross-sectional area of the stranded element wires 5 is 2.50 mm², when the number of the element wires 5 is less than 37, the bending times until at least one element wire 5 is broken is reduced due to a degradation of mechanical strength. Further, when the number of the element wires 5 is more than 84, an outer diameter of the core wire 3 is thick, and rigidity of the core wire 3 is increased, thereby flexibility of the electric wire 1 is reduced.

Further, according to FIG. 9, in the electric wire 1 according to the first embodiment and the electric wire 1 according to the second embodiment, when the strand pitch of the stranded element wires 5 is equal to or more than 3 times and equal to or less than 40 times of the center diameter ‘B’ of the core wire 3, the element wire 5 of the electric wire 1 made of aluminum or aluminum alloy can be prevented from being broken even when used in a wiring harness routed in a vehicle. Namely, fatigue strength of the element wire 5 can be improved.

From a measurement result of the number of bending times until the element wire 5 is broken, in the electric wire 1 of the first embodiment, when the total cross-sectional area of the stranded element wires 5 is equal to or more than 0.34 mm² and equal to or less than 2.61 mm², the number of bending times is equal to or more than 1000. Incidentally, to make the number of bending times of the electric wire 1 equal to or more than 2000, preferably, the total cross-sectional area of the stranded element wires 5 is equal to or more than 0.45 mm² and equal to or less than 1.40 mm².

From the measurement result of the number of bending times until the element wire 5 is broken, in the electric wire 1 of the second embodiment, when the total cross-sectional area of the stranded element wires 5 is equal to or more than 0.65 mm² and equal to or less than 6.54 mm², the number of bending times is equal to or more than 1000. Incidentally, to make the number of bending times of the electric wire 1 equal to or more than 2000, preferably, the total cross-sectional area of the stranded element wires 5 is equal to or more than 1.40 mm² and equal to or less than 2.90 mm².

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

### REFERENCE SIGNS LIST

1 electric wire

3 core wire

5 element wire

‘A’ strand pitch

‘B’ center diameter

1. An electric wire comprising:
a core wire made by stranding a plurality of element wires, each of said element wire being made of aluminum or aluminum alloy, and each of said element wire having a circular sectional shape; and
an insulating cover covering the core wire,
wherein the number of the element wires is equal to or more than 19 and equal to or less than 37,
wherein a diameter of the element wire is equal to or more than 0.15 mm, and equal to or less than 0.30 mm,
wherein a total cross-sectional area of the stranded element wires is equal to or more than 0.34 mm² and equal to or less than 2.61 mm², and
wherein a strand pitch of the stranded element wires is equal to or more than 3 times and equal to or less than 40 times of a center diameter of the core wire.

2. An electric wire comprising:
a core wire made by stranding a plurality of element wires, each of said element wire being made of aluminum or aluminum alloy, and each of said element wire having a circular sectional shape; and
an insulating cover covering the core wire,
wherein the number of the element wires is equal to or more than 37 and equal to or less than 84,
wherein a diameter of the element wire is equal to or more than 0.15 mm, and equal to or less than 0.315 mm,
wherein a total cross-sectional area of the stranded element wires is equal to or more than 0.65 mm² and equal to or less than 6.54 mm², and
wherein a strand pitch of the stranded element wires is equal to or more than 3 times and equal to or less than 40 times of a center diameter of the core wire.
